(19) United States
(12) Patent Application Publication
(10) Pub. No.: US 2011/0020631 A1
(43) Pub. Date: Jan. 27, 2011

(54) Coated Carbon Foam Article

(76) Inventors: Douglas J Miller, Broadview Heights, OH (US); Robert A. Mercuri, Seven Hills, OH (US); Irwin C. Lewis, Oberlin, OH (US); Richard L. Shao, North Royalton, OH (US); Gary Dale Shives, Brunswick, OH (US); Gerald F. Hoffert, Euclid, OH (US); David M. Kaschak, Olmsted Falls, OH (US)

Correspondence Address: GrafTech International Holdings, Inc., 12900 Snow Road, Parma, OH, 44130, US

(21) Appl. No.: 12/669,300

(22) PCT Filed: Sep. 5, 2008
(86) PCT No.: PCT/US08/75315

§ 371 Date: Oct. 11, 2010

Related U.S. Application Data
(60) Provisional application No. 60/971,425, filed on Sep. 11, 2007.
(60) Provisional application No. 60/992,779, filed on Dec. 6, 2007.

(51) Int. Cl. B32B 3/26

(52) U.S. Cl. 428/315.5; 428/304.4; 428/319.3

(57) ABSTRACT

A carbon foam article useful for, inter alia, composite tooling or other high temperature applications, which includes a carbon foam substrate, an intermediate material on a surface of the carbon foam substrate, and a tool facing material on an outer surface of the article such that the intermediate material is positioned between the tool facing material and the carbon foam substrate.

### RELATED APPLICATION

This application claims the benefit of copending and commonly assigned WIPO Application have Serial No. PCT/US08/075315, entitled Coated Carbon Foam Article, filed Sep. 5, 2008, provisional U.S. Application having Ser. Nos. 60/971,425, entitled Carbon Foam Tool, filed on Sep. 11, 2007, 60/992,779, entitled Coated Carbon Foam Article, filed Dec. 5, 2007, 61/144,785, entitled Coated Carbon Foam Article, filed Jan. 15, 2009 in the name of Gary D. Shives et al., the disclosures of which are incorporated herein by reference in their entirety.

### BACKGROUND OF THE INVENTION

1. Technical Field

This disclosure relates to carbon foams useful for applications including composite material tooling and others. More particularly, the disclosure relates to a tool which includes carbon foam, and also includes methods for the production of such foams and tools from such foam.

2. Background Art

Carbon foams have attracted considerable recent activity because of their properties of low density, coupled with either very high or low thermal conductivity. Conventionally, carbon foams are prepared by two general routes. Highly graphitizable foams have been produced by thermal treatment of mesophase pitches under high pressures. These foams tend to have high thermal and electrical conductivities. For example, in Klett, U.S. Pat. No. 6,033,506, a mesophase pitch is heated while subjected to a pressure of 1000 psi to produce an open-cell foam containing interconnecting pores with a cell size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cc).

In Hardcastle et al. (U.S. Pat. No. 6,776,936) carbon foams with densities ranging from 0.678-1.5 g/cc are produced by heating a pitch in a mold at pressures up to 800 psi. The foam is alleged to be highly graphitizable and provide high thermal conductivity (250 W/m-K).

According to H. J. Anderson et al. in Proceedings of the 43^{rd} International SAMPE Meeting, p 756 (1998), carbon foam is produced from a mesophase pitch followed by oxidative thermosetting and carbonization to 900° C. The foam has an open cell structure with interconnecting pores, having varying cell shapes and diameters ranging from 39 to greater than 480 microns.

Rogers et al., in Proceedings of the 45^{th} SAMPE Conference, pg 293 (2000), describe the preparation of carbon foams from coal-based precursors by heat treatment under high pressures to give materials with densities of 0.35-0.45 g/cc with compressive strengths of 2000-3000 psi (thus a strength/density ratio of about 6000 psi/g/cc). These foams have an open-celled structure of interconnected pores with cell sizes ranging up to 1000 microns. Unlike the mesophase pitch-derived foams described above, they are not highly graphitizable. In a recent publication, the properties of this type of foam were described (High Performance Composites September 2004, pg. 25). The foam has a compressive strength of 800 psi at a density of 0.27 g/cc or a strength to density ratio of 3000 psi/g/cc.

Stiller et al. (U.S. Pat. No. 5,888,469) describe production of carbon foam by pressure heat treatment of a hydrotreated coal extract. These materials are claimed to have compressive strengths of 600 psi for densities of 0.2-0.4 g/cc (strength/density ratio of from 1500-3000 psi/g/cc). It is suggested that these foams are stronger than those having a glassy carbon or vitreous nature which are not graphitizable.

Carbon foams can also be produced by direct carbonization of polymers or polymer precursor blends. Mitchell, in U.S. Pat. No. 3,302,999, discusses preparing carbon foams by heating a polyurethane polymer foam at 200-255° C. in air followed by carbonization in an inert atmosphere at 900° C. These foams have densities of 0.085-0.387 g/cc and compressive strengths of 130 to 2040 psi (ratio of strength/density of 1529-5271 psi/g/cc).

In U.S. Pat. No. 5,945,084, Droege described the preparation of open-celled carbon foams by heat treating organic gels derived from hydroxylated benzenes and aldehydes (phenolic resin precursors). The foams have densities of 0.3-0.9 g/cc and are composed of small mesopores with a size range of 2 to 50 nm.

Mercuri et al. (Proceedings of the 9^{th} Carbon Conference, p. 206 (1969) prepared carbon foams by pyrolysis of phenolic resins. For foams with a density range of 0.1-0.4 g/cc, the compressive strength to density ratios were from 2380 to 6611 psi/g/cc. The cells were ellipsoidal in shape with cell diameters of 25-75 microns) for a carbon foam with a density of 0.25 g/cc.

Stankiewicz (U.S. Pat. No. 6,103,149) prepares carbon foams with a controlled aspect ratio of 0.6-1.2. The patentee points out that users often require a completely isotropic foam for superior properties with an aspect ratio of 1.0 being ideal. An open-celled carbon foam is produced by impregnation of a polyurethane foam with a carbonizable resin followed by thermal curing and carbonization. The cell aspect ratio of the original polyurethane foam is thus changed from 1.3-1.4 to 0.6-1.2.

Unfortunately, some carbon foams produced by the prior art processes are not effective for many high temperature applications such as composite tooling. The foams generally available are not monolithic and do not have the strength and strength to density requirements for such application. In addition, open-celled foams with highly interconnected pores have porosities making them ill-placed for such applications.

In U.S. Published Patent Application No. US2006/086043, Douglas J. Miller, Irwin C. Lewis and Robert A. Mercuri disclose a carbon foam which overcomes the noted deficiencies in foams produced by prior art processes. More specifically, the Miller et al. foam has a bimodal cell structure, with a combination of larger and smaller relatively spherical pores, which provide a carbon foam which can be produced in a desired size and configuration and which can be readily machined, providing a carbon foam which exhibits a density, compressive strength and compressive strength to density ratio to provide a combination of strength and relatively light weight characteristics not heretofore seen. This bimodal pore distribution provides a combination of two average pore sizes, with the primary fraction being the larger size pores and a minor fraction of smaller size pores.

However, in order to function as composite tooling, most carbon foams require a facing layer to be applied to the surface on which tooling is to be effected. The semi-porous nature of the foam, as well as possible mismatches in coefficient of thermal expansion (CTE) between the foam and the facing layer, can hinder the effective use of carbon foam in tooling application.

What is desired, therefore, is a process for preparing a carbon foam article capable of use in application such as composite tooling. More specifically, a process for preparing an article comprising a carbon foam core and facing layer thereon, and the article thus prepared, is sought. The desired carbon foam article is monolithic and has a controllable cell structure, where the cell structure, strength and strength to density ratio make the foam suitable for use as composite tooling as well as in other applications. Indeed, a combination of characteristics, including strength to density ratios higher than contemplated in the prior art, have been found to be highly advantageous for use of a carbon foam in composite tooling applications.

### BRIEF DESCRIPTION

An embodiment disclosed herein relates to an article useful as a tool for composite tooling which includes a carbon foam substrate, an intermediate layer on at least one surface of the substrate, and a facing layer on the intermediate layer. A method of making the tool may include disposing the intermediate layer in the form of a film on a surface of a carbon foam substrate and applying the facing layer onto the intermediate layer. The intermediate layer may be cured (partially or fully) prior to the application of the facing layer or the intermediate layer and the facing layer may be co-cured in place.

More particularly, one embodiment, disclosed herein includes a carbon article having a carbon foam substrate, an intermediate material on a surface of the substrate, and a tool facing material on an outer surface of the article, which may also be on a top surface of the intermediate material. The carbon foam advantageously has a ratio of compressive strength to density of at least about 7000 psi/(g/cc), a density of from about 0.05 to about 0.4 g/cc and a compressive strength of at least about 2000 psi. Indeed, in a preferred embodiment, the carbon foam has a porosity of between about 65% and about 95%. Preferably, at least about 90% of the volume of the pores have a diameter of between about 10 and about 150 microns and at least about 1% of the volume of the cells have a diameter of between about 0.8 and about 3.5 microns.

In a certain embodiment, the intermediate material can be an elastomeric or rigid material, in the form of a sheet, or one that is deposited by a surface treatment process. In one embodiment, the intermediate material may be formed from more than one elastomeric sheet (also known as a film), e.g., adjacent sheets in a lapped relationship to each other. In one embodiment, the intermediate layer includes at least one material selected from the group of elastomer, benzoxazine resin, filled polyimide resin, phenolic resin, epoxy resin, bismalimide resin film adhesive, polyimide composites, or high temperature paste adhesive and combinations thereof.

A further embodiment disclosed herein includes the carbon foam substrate and a film layer on a top surface of the foam substrate. The film may function as the above intermediate layer and the facing layer. Preferably, the film will exhibits the advantageous of both the intermediate layer and the facing layer discussed herein. In a particular embodiment, the film layer may comprise a ceramic matrix composite material (CMC). The composite material may feature glass, metal and synthetic matrices and be reinforced with silicon carbide fiber. One example of a suitable matrix material may be alumino-silicate oxides. Alternatively, the matrix may be other types of thermosetting materials.

It is to be understood that both the foregoing general description and the following detailed description provide embodiments of the invention and are intended to provide an overview or framework of understanding and nature and character of the invention as it is claimed. The accompanying drawing is included to provide a further understanding of the invention and is incorporated in and constitutes a part of the specification. The drawing illustrates various embodiments of the invention and together with the description serves to describe the principles and operations of the invention.

### BRIEF DESCRIPTION OF THE DRAWINGS

FIG. 1 is a schematic view of an embodiment of a tool disclosed herein.

### DETAILED DESCRIPTION OF THE PREFERRED EMBODIMENTS

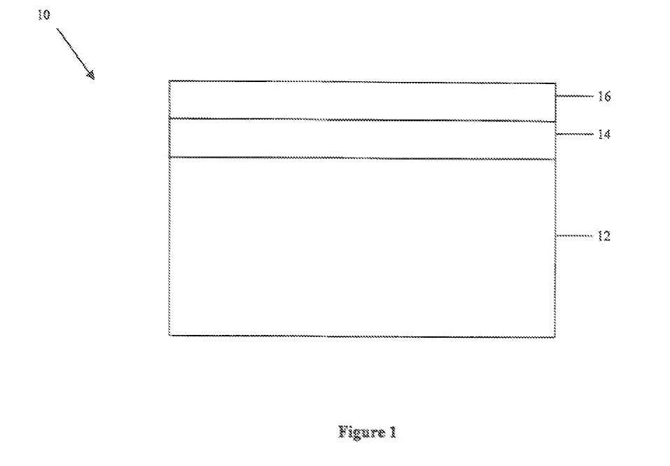

Illustrated in FIG. 1 is a cross sectional view of an embodiment of a carbon foam article 10 useful as a tool for a composite tooling application. Article 10 includes a carbon foam substrate 12. The carbon foam from which substrate 12 is formed can be made from any type of precursor material such as, but not limited to: coal, pitch, mesophase pitch and/or polymeric foam. In one embodiment, substrate 12 may be made from more than one piece of carbon foam. In such an embodiment the pieces of carbon foam may be joined together by the use of a carbonaceous cement. In another embodiment, the pieces of foam may be joined together by the use of a film, an adhesive or by an elastomeric sheet between the adjacent pieces of foam. Preferably the material used to bond the foam will withstand the highest processing temperature of the either or both of the process of making the tool and/or using the tool. Examples of suitable temperatures for such an adhesive include up to more than about 540° C. In one particular embodiment, the temperature stability of the adhesive is up to about 300° C., in another embodiment up to about 250° C. Some examples of suitable materials for bonding blocks of carbon foam include Pelseal® 3159 (a fluoro-elastomer available from Pelseal Technologies LLC), Hysol® EA 9394/C-2 (a thermosetting plastic available from Dexter Corp.), Fluorolast WB® 200 (a polymeric coating available from Laurnell International Inc.), X-Pando® (available from X-Pando Corp.), BMI resin, and C34™ cement (available from GrafTech International Holdings Inc.). In another embodiment, substrate 12 is formed of a monolithic block of carbon foam.

As noted, the carbon foam may be formed from other materials such as pitch, coal, and/or other carbonizable materials which may be foamed. In a preferred embodiment, however, the carbon foam used to form carbon foam substrate 12 is prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resoles catalyzed by sodium hydroxide at a formaldehyde: phenol ratio which can vary, but is preferably about 2:1. Free phenol and formaldehyde contents should be low, although urea may be used as a formaldehyde scavenger.

The foam is prepared by adjusting the water content of the resin and adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol, however, other phenols of the kind which are able to form condensation products with aldehydes can also be used. Such phenols include monohydric and polyhydric phenols, pyrocatechol, hydroquinone, alkyl substituted phenols, such as cresols or xylenols; polynuclear monohydric or polyhydric phenols, such as naphthols, p.p′-dihydrexydiphenyl dimethyl methane or hydroxyanthracenes.

The phenols used to make the foam starting material can also be used in admixture with non-phenolic compounds which are able to react with aldehydes in a similar fashion as phenols react.

The preferred aldehyde for use in the solution is formaldehyde. Other suitable aldehydes include those which will react with phenols in the same manner. These include, for example, acetaldehyde and benzaldehyde.

In general, the phenols and aldehydes which can be used in the process of the invention are those described in U.S. Pat. Nos. 3,960,761 and 5,047,225, the disclosures of which are incorporated herein as reference.

The polymeric foam used as the starting material in the production of the inventive carbon foam should have an initial density which mirrors the desired final density for the carbon foam which is to be formed. In other words, the polymeric foam should have a density of about 0.01 to about 0.6 g/cc, more preferably about 0.01 to about 0.5 g/cc. In terms of a carbon foam for use as carbon foam substrate 12, a preferable density is less than about 1.0 g/cc; preferably less than about 0.6 g/cc. In a further embodiment, preferably, foam used to form substrate 12 has a density of at least about 0.03 g/cc. The cell structure of the polymeric foam should have a porosity of between about 65% and about 95% and a relatively high compressive strength, i.e., on the order of at least about 100 psi, and as high as about 300 psi or higher.

Advantageously, the carbon foam has a relatively uniform distribution of pores. Also, it is preferred that the pores are relatively isotropic, by which is meant that the pores are relatively spherical, meaning that the pores have, on average, an aspect ratio of between about 1.0 (which represents a perfect spherical geometry) and about 1.5. The aspect ratio is determined by dividing the longer dimension of any pore with its shorter dimension.

As noted, the carbon foam may have a total porosity of about 65% to about 95%, more preferably about 70% to about 95%. In addition, it has been found highly advantageous for the foam to have a bimodal pore distribution, that is, a combination of two average pore sizes, with the primary fraction being the larger size pores and a minor fraction of smaller size pores. Preferably, of the pores, at least about 90% of the pore volume, more preferably at least about 95% of the pore volume should be the larger size fraction, and at least about 1% of the pore volume, more preferably from about 2% to about 10% of the pore volume, should be the smaller size fraction.

The larger pore fraction of the bimodal pore distribution in the carbon foam should comprise pores from about 10 to about 150 microns in diameter, more preferably about 15 to about 95 microns in diameter, most preferably about 25 to about 95 microns in diameter. The smaller fraction of pores should comprise pores that have a diameter of about 0.8 to about 3.5 microns, more preferably about 1 to about 2 microns. The bimodal nature of the pore distribution in the foam used to form carbon foam substrate 12 provides an intermediate structure between open-celled foams and closed-cell foams, thus limiting the liquid permeability of the foam while maintaining a foam structure. Indeed, advantageously, the carbon foam should exhibit a nitrogen permeability of no greater than about 3.0 darcys, more preferably no greater than about 2.0 darcys (as measured by ASTM C577).

Typically, characteristics such as porosity and individual pore size and shape are measured optically, such as by use of an epoxy microscopy mount using bright field illumination, and are determined using commercially available software, such as Image-Pro Software available from MediaCybernetic of Silver Springs, Md.

In order to convert the polymeric foam to carbon foam, the polymeric foam is carbonized by heating to a temperature of from about 500° C., more preferably at least about 800° C., up to about 3200° C., in an inert or air-excluded atmosphere, such as in the presence of nitrogen. The heating rate should be controlled such that the polymer foam is brought to the desired temperature over a period of several days, since the polymeric foam can shrink by as much as about 50% or more in volume during carbonization. Preferably, the polymeric foam is substantially uniformly heated.

By use of a polymeric foam heated in an inert or air-excluded environment, a non-graphitizing glassy carbon foam is obtained, which has the approximate density of the starting polymer foam, but a compressive strength of at least about 2000 psi and, significantly, a ratio of strength to density of at least about 7000 psi/(g/cc), more preferably at least about 8000 psi/(g/cc). The carbon foam has a relatively uniform distribution of isotropic pores in a bimodal pore size distribution as described hereinabove, the pores having, on average, an aspect ratio of between about 1.0 and about 1.5.

In a further embodiment, substrate 12 may be constructed from conductive carbon foam. In one embodiment, the foam may have density which ranges from about 0.15 g/cc to greater than about 0.45 g/cc. In a particular embodiment, conductive foam of substrate 12 has a substantially uniform density in the rise direction, more preferably in the rise direction as well as the horizontal directions. The bulk thermal conductivity of the conductive foam may be at least about 20 W/mK, preferably at least about 40 W/mK, more preferably at least about 100 W/mK, and even more preferably at least about 150 W/mK. In one embodiment, the thermal conductivity is up to about 180 W/mK.

Preferably the conductive foam has a compressive strength of at least about 15 psi, more preferably at least about 50 psi, even more preferably at least about 100 psi, and most preferably at least about 150 psi. In one particular embodiment, the compressive is up to about 200 psi. In further embodiments, the conductive foam may include pores in the pore structure having a pore size of at least about 100 microns up to about 500 microns. Additionally, such foam may include a pore concentration of about 20 pores per inch; up to about 100 pores per inch

Referring again to FIG. 1, an intermediate material 14 is positioned on a top surface of carbon foam substrate 12. In one embodiment disclosed herein, material 14 is about 1 to about 60 mils, preferable about 3 to 40 mils, more preferably about 5 to 20 mils in thickness. Article 10, when used as a tool, further includes a tool facing material 16 on an outer surface thereof.

Some advantageous materials for use as intermediate layer 14 may provide some or all of the following benefits of: (1) the material 14 may accommodate a mismatch in the coefficient of thermal expansion (“CTE”) between substrate 12 and facing material 16; (2) the material 14 may provide strength at the interface between carbon foam substrate 12 and tooling facing material 16; (3) the material 14 may provide a desired amount of elasticity at the interface between substrate 12 and facing material 16; and (4) the material 14 may be suitable to seal the surface of substrate 12 in such a manner that facing material 16 would not seep into the body of substrate 12 during application and/or curing of facing material 16. Other desirable properties for intermediate material 14 include thermal stability such that the material withstands thermal cycling incurred as part of the process of making tool 10 as well as the thermal cycling incurred during use of tool 10. In one particular embodiment, a favorable intermediate material 14 is compliant, will render substrate 12 impermeable, and will forgive stresses due to a mismatch in CTE between substrate 12 and tool facing 16.

In an advantageous embodiment, intermediate material 14 comprises an elastomeric material, which may be in the form of a sheet or film. Examples of suitable elastomeric materials include butyl rubber, syndiotactic rubber, ethylene-propylene-diene monomer (EPDM), and fluorine containing elastomer or fluoroelastomer (the fluorine containing elastomer may be cured or uncured). In one embodiment, the fluoroelastomer is in liquid form. Other examples of suitable intermediate materials 14 include benzoxazine film, phenolic resin, film adhesive with an intermediate layer, high temperature paste adhesive, and/or epoxy resin. Commercially available examples of such intermediate materials include Hysol® 9394/C-2 epoxy resin from Henkel, Cytec FM2550B from Cytec Engineered Materials, Inc., a bismaleimide resin (BMI)/polyimide/glass carrier/BMI layered material, Beta 8610 adhesive film from Airtech, 1069 Viton Rubber from Airtech, a fluoroelastomer, HTE 18-75E with or without LTE 16-40B from Advanced Composite Group, Ltd, Pelseal 3159, Pelseal PLV-6023 fluoroelastomer, Lauren Fluorolast WB-200, and XU 3560 from Huntsman. Furthermore, intermediate material 14 may be made of one or more than one coats or layers of the above elastomeric material.

In an additional embodiment, intermediate material may be in the form of a filler. Material 14 in the form of a filler may provide some or all of the following benefits: (1) once applied to a top surface of the substrate it may reduce the surface roughness of the top surface of the substrate-filler combination to less than the surface roughness of the substrate alone, preferably reducing the roughness by at least about ⅓, more preferably at least about ½; (2) material 14 as a filler may have a sufficient viscosity so that it can be easily dispersed along a top surface of substrate 12 and that the material sufficiently fills any cells, voids, depressions, or other irregularities on such surface of substrate 12 whereby the combination of substrate 12 and filler material 14 would have a top surface which is substantially void free and substantially smooth; (3) the material 14 may include particles; and/or (4) sufficiently fills the cells, depressions and/or voids of substrate 12 so that when facing material 16 is added, tool 10 may have a working surface with a desired smoothness and vacuum integrity. Alternatively filler material 14 may or may not provide sufficient vacuum integrity.

Preferably any particles present in filler material 14 are sized to fill any cells, depressions, etc. open to a top surface of substrate 12. Some examples of suitable particle sizes include less than about 150 microns, less than about 100 microns, less than about 50 microns, less than about 25 microns, and less than about 10 microns. Examples of suitable materials for the particles include carbonaceous materials, such as carbon and/or graphite powders, clay, talc, calcium carbonate, quartz, and combinations thereof.

Preferably, filler material 14 is a material which may expand upon the thermal cycling during the process of making a part and/or of making tool 10, however, it is further preferred that the filler material 14 in expanding does not expand with sufficient force to stress the internal structure of substrate 12. Some examples of materials which may be used as filler material 14 include an acrylic based material, a gypsum based material, a nitrocellulose based material, and combinations thereof.

In a further embodiment, material 14 may comprise a composite of more than one of the above materials. In an additional embodiment of the composite material, material 14 may include a conductive material in addition to one or more of the above materials. Examples of the material may include a sheet of flexible graphite, such as eGRAF® material from GrafTech International Holdings Inc., or a conductive elastomer laminate manufactured by Chomerics, Inc. of 23839 S. Banning Blvd., Carson Calif. 90475. The CHO-THERM T274 material consists of an extremely soft (hardness value of 3 durometers) silicon elastomer loaded with aluminum oxide particles and laminated to a thermally conductive reinforcing material, such as fiberglass, which resists puncture and eases handling.

Referring to FIG. 1, in an embodiment of tool 10, filler material 14 is positioned on a top surface of carbon foam substrate 12. In one embodiment disclosed herein, material 14 does not extend above the top surface by a distance of more than about 25 μm, preferable no more than 15 μm, more preferably no more than about 10 μm. In a further particular embodiment, filler 14 only nominally extends above the top surface of substrate 12.

In another particular embodiment, intermediate material 14 may be used to accommodate a carbon foam substrate 12 and a tool facing material 16 having different CTEs. In other words, when there is a mismatch between the CTE of carbon foam substrate 12 and that of tool facing material 16, intermediate material 14 can permit the effective use of mismatched CTE substrate 12 and tool facing material 16. In another embodiment, more than one elastomeric sheet can be used to form intermediate material 14. Preferably, in this embodiment, adjacent sheets are joined together in a lapped relationship to one another.

In yet another embodiment, intermediate material 14 is constructed from a material that functions to prevent resin used to form tool facing material 16 from seeping into carbon foam substrate 12 during curing, e.g., autoclave curing.

In a further embodiment, intermediate material 14 may comprises a modified polyimide. The polyimide may be in a form of a film or in viscous form that may be spread along on or more surfaces of substrate 12. In a certain embodiment, the polyimide is modified with a carbonaceous containing polymer. One example of such a carbonaceous filler includes coke particles. Other examples of carbonaceous materials include carbon or graphite powder, clay and talc. An example of a preferred particle size for the filler includes about 10 to 40 microns. Optionally the polyimide may include other modifying agents if so desired.

Tool facing material 16 can be any material suitable for forming a surface on article 10 which can be used for tooling applications. In other words, tool facing material 16 must provide characteristics which can be used in tooling, such as impermeability, smoothness, durability and ability to withstand the high temperatures employed during tooling operations. Advantageously, tool facing material 16 is a cured resin, although other materials, such as ceramics, metallic material, powders or films and the like can also be employed. The various examples may also be used in any combination thereof. Examples of suitable resins include epoxies, polyimides, bismaleimide, epoxy-acrylic material, cyanate ester, cyanate epoxy and combinations thereof. Optionally, the resin may also include a reinforcement material such as basalt fibers tensile up to 4000 MPa, temperatures up to about 700° C., thermal conductivity no more than about 0.035 W/mk, carbon fibers, carbon nanotubes, fiber glass, graphite fiber, graphite nanotubes, graphene, and combinations thereof. In addition, the reinforcement material may be in the form of a woven mat. Examples of available materials which may be used as tool facing material 16 include Hextool M61 from Hexcel, Duratool 450 from Cytec, HTM 512, HTM 512-1, HTM 512-2, and HTM 552 all from Advanced Composite Group, Ltd. Other types of material which may be used as tool facing material 16 include INVAR®, which is a nickel-steel or nickel-iron alloy sometimes referred to as 64FeNi or FeNi36, silicon carbide, zirconia ceramics and combinations thereof. The various materials of tool face material 16 may be used in any combination thereof. Optionally, a top surface of material 16 (in the orientation illustrated in FIG. 1) may be covered with a release coating or a release liner which thus forms a top surface of article 10. In another alternate embodiment, tool facing material 16 may include a polyimide barrier film in addition to the cured resin adjacent material 14. One example of such film includes KAPTON® film available from DuPont.

One method of forming article 10 includes applying intermediate material 14 to carbon foam substrate 12 and then curing material 14, if material 14 is applied to substrate 12 in an uncured state. Material 14 may be applied in a solid or liquid form. Optionally, prior to curing intermediate material 14, a negative pressure may be applied to substrate 12 in a manner to advance or partially impregnate material 14 into substrate 12. Typically material 14 is semi-cured (i.e., at least 25% cured, but no more than about 90% cured) by heating the assembly of substrate 12 and material 14 to a temperature of at least about 150° F. Certain embodiments of material 14 may at least semi-cure at room temperature, thus eliminating the need for the semi-cure heating step.

Next, tool facing material 16 is applied to a top surface of the at least semi-cured intermediate material 14. The facing material 16 is then cured by the application of heat and pressure. In one embodiment, facing material 16 applied in an uncured state is also known as a prepreg. Typical curing temperatures are at least about 300° F., preferably at least about 350° F.

In one embodiment, an autoclave may be used to cure intermediate material 14 and/or facing material 16.

A further method of making article 10 includes applying intermediate material 14 to a top surface of substrate 12. Then tool facing material 16 is applied to a top surface of intermediate material 14, after which both intermediate material 14 and facing material 16 are cured. Typically in this embodiment, intermediate material 14 is in the form of a sheet.

In one particular embodiment intermediate material 14 is applied to substrate 12 in more than one step. In this embodiment a first elastomer having a first viscosity is applied to substrate 12. The elastomer may be applied in the form of a sheet or a liquid. The liquid form of the elastomer may be applied by any one of the techniques of spraying, rolling, painting, and combinations thereof. Preferably the liquid substrate may penetrate into the body of substrate 12. The penetrating liquid elastomer may fill some of the pore volume of substrate 12 and/or seal connections between pores of substrate 12. Optionally the elastomer having the first viscosity may be applied in one or more applications.

Next, a second elastomer having a second viscosity may be applied to coated substrate 12. First and second elastomers may be the same or different materials. Preferably, the first viscosity is either greater than or less than the second viscosity. In a preferred embodiment the second viscosity is greater than the first viscosity. The second elastomer may be applied in the same manner as the first elastomer.

Lastly, a third elastomer may optionally be applied on top of the second elastomer. The viscosity of the third elastomer may be greater than or less than the viscosity of the second elastomer. In a preferred embodiment the viscosity of the third elastomer is greater than the viscosity of the second elastomer. The third elastomer may be the same or different of either one of the first elastomer and the second elastomer or all elastomers may be the same. The same techniques to apply the first and second elastomers may also be used to apply the third elastomer. In this embodiment, the second layer may include a carbonaceous filler such as coke if desired. As such the carbanceous filler of the second elastomer may be the same or different as the filler included in the modified polyimide. The difference may be in the type of material or one or more properties of the material.

In this particular embodiment, substrate 12 covered with intermediate material 14 may or may not have tool facing material 16 applied thereon, yet still function as an article 10 useful as a tool for tooling applications. Lastly, substrate 12 coated with intermediate material 14 may be impervious to liquids such as water and have a sufficient density that article 10 would float.

Machining of the tool may also take place. The tool may be machined in any desired manner. In one such manner, the desired tool image is machined into the facing material. Alternatively, substrate 12 may be machined and the desired outer materials (intermediate material 14 and/or facing material 16) may be applied to the machined surface of substrate 12. In a further alternative, intermediate material 14 may be a surface that is machined. Additionally, more than part of tool 10 may be machined. For example, but not limited to, a rough image of the desired shape may be machined into a surface of substrate 12. then a final image of the desired shape may be machined into facing material 16. Preferably, machining takes place in an enclosed environment. Two examples of machining tools include carbide and diamond tools.

If desired to reduce the moisture content of substrate 12, it may be dried prior to sealing. Typically substrate 12 is dried by a thermal process. In one embodiment, substrate 12 is dried by exposing substrate 12 to a temperature of 100 to 200° C., for up to 30 hours, one preferred embodiment is a temperature of about 120 to 150° C. for a drying period of about 12 to 24 hours. Examples of a preferred moisture level include moisture level of less than about 5% by wgt, less than about 2% by wgt, less than about 1% by wgt, and less than about 0.5% by wgt. Preferably substrate 12 is sealed within 48 hours or less of drying, more preferably within 36 hours or less of drying.

In addition to drying, or alternatively instead of drying, substrate 12 may include vent channels. The vent channels may be drilled into substrate 12, the vents may be aligned milled slots in pieces of foam to be bonded together to from all or part of substrate 12, or any other technique suitable for forming channels in substrate 12. A preferred venting area may vary based on the density of substrate 12. For example, vent area per tool (substrate 12) volume may range to 1.0 to 5.0 m² of vent area/m³ of tool volume, preferably 1.5 to 4.0. Additionally, the denser substrate 12, the more vent channels substrate 12 may include. For example, the distance between vent channels may range from about 100 cm to about 10 cm. For substrate 12 having a density of less than about 0.25 g/cc, the vent channels may be about 50 to 100 cm apart. For substrate 12 with a density of about 0.25 g/cc or greater, the vent channels should be about 50 to 10 cm apart.

In one particular embodiment of article 10, article 10 is constructed from a material such that article 10 may be used as a tool at a use temperature of up to about 300° C. It is further preferred, that such article 10 would be suitable for use as a tool for peak use temperatures of up to about 450° C. In another embodiment, the tool may have a use temperature up to about 650° C.

In a one certain embodiment of tool 10, facing material 16, has a top surface, such surface also known as a working surface, wherein at least a majority of the surface has a surface roughness of no more than about 63 μ-in, preferably no more than about 50 μ-in, more preferred no more than about 40 μ-in, and even more preferred no more than about 30 μ-in. Preferably for any one of the above embodiments, at least about seventy-five (75%) of the surface has the aforementioned surface roughness, more preferably at least about ninety (90%), and even more preferably substantially all, and, most preferably, all of the working surface has the aforementioned surface roughness. A Phase II TR100 Surface Roughness Tester (“Tester”) may be used to determine the surface roughness. In one particular embodiment, the surface roughness is determined by using the Tester on more than one location of the top surface of facing material 16. In one embodiment, the Tester may use a root-mean square (“RMS”) algorithm to calculate the surface roughness. However, any suitable algorithm maybe used to calculate the surface roughness. A non-limiting example of another such algorithm is an arithmetic mean. Optionally, if desired, the tool surface may be wet sanded to reduce surface roughness. It is further preferred that during formation of tool 10 as well as during use of tool 10, that facing material 16 does not develop microcracks or other defects which would inhibit vacuum integrity.

In another certain embodiment, regarding vacuum integrity, it is preferred that tool 10 will maintain vacuum integrity to the extent to have no more than about 0.5 in-Hg of loss over a time period of at least about five (5) minutes, preferably at least about twenty (20) minutes, and more preferably at least about thirty (30) minutes. In a further embodiment, the loss is no more than about 0.2 in-Hg for the above given time periods, preferably no more than about 0.1 in-Hg.

An advantage of one or more of the above embodiments include, the ability to form a tool with sufficient vacuum integrity. Another advantage is that the tool may have sufficient chemical stability as well as temperature stability. A further advantage is that the tool is made from components that have a sufficient CTE match. An additional advantage is that the tool may be a light weight tool. The advantages may also include that the substrate as a sufficient filled surface that the top surface of the tool may be finished to an appropriate smoothness on a micron level.

With respect to surface 16, preferably facing material 16 is located on a top surface of the assembly of the substrate 12 and filler 14. It is preferred that facing material 16 has a thickness of no more than about 500 μm, preferably no more than about 400 μm, and even more preferred no more than about 250 μm. Preferably facing material 16 is of a sufficient viscosity that it can be applied in a substantially liquid form, by rolling, brushing, squeegeeing, spraying operations or the like. In one particular embodiment, facing material 16 is stable at temperatures greater than about 250° F. It is also preferred that facing material 16 has a sufficient amount of elasticity for thermal cycling such that the material 16 will not delaminate from the rest of tool 10 during thermal cycling of at least about 350° F., preferably at least about 375° F. It is also preferred that material 16 will maintain vacuum integrity. It is further preferred that facing material 16 can withstand autoclave curing at temperatures of at least about 350° F. at pressures of about 100 psi, further temperatures of at least about 375° F. An example of a material that may be useful as facing material 16 is an epoxy-acrylic material.

In a further particular embodiment of tool 10 described in terms of CTE, both intermediate material 14 and facing material 16 each have a coefficient of thermal expansion (“CTE”) which is less than about 20 times greater than the CTE of substrate 12, preferably, no more than about 15 times greater, and even more preferably no more than about 10 times greater.

Tool 10 disclosed herein is not limited to any particular number of layers on top of a surface of substrate 12; in one embodiment, the number of layers includes less than about 6; in a further embodiment less than about 3; and in another embodiment less than about 2.

The above various embodiments, may be practiced individually or in any combination thereof.

In order to further illustrate the principles and operation of the present invention, the following example is provided. However, this example should be taken as illustrative only and not limiting in any regard.

### Example

A rectangular phenolic foam block with dimensions of 7.8 inches long, 3.9 inches wide and 2.9 inches thick is converted to carbon foam in the following manner. The starting phenolic foam has a density of 0.32 g/cc, and a compressive strength of about 300 psi. The foam is packed in a steel can, protected from air and then heated at 2° C. per hour to a temperature of 550° C. and then at 10° C. per hour to 900° C. and held for about 20 hours at that temperature. The resultant carbon foam has a density of 0.336 g/cc and a compressive strength of 4206 psi, for a strength to density ratio of 12,517 psi/(g/cc). The thermal conductivity of the foam is measured as 0.3 W/m-K at 25° C. and the nitrogen permeability is measured as 0.17 darcys.

The foam is examined by optical microscopy and the porosity of the foam is measured as 79.5%. Two sets of cells are observed, and the cells appear round with fairly uniform diameters. An image analysis procedure is used to determine the average diameters and aspect ratios of the two different sets of cells. For the large size cells, with diameters above 25 microns, the calculated average diameter is 35 microns with a standard deviation of 4.7 microns. The pore aspect ratio is calculated as 1.16 showing they are essentially spherical. These large pores account for 96% of the pore volume of the total porosity. The finer size pores, which account for 4% of the pore volume of the total porosity, have an average diameter of 1.73 microns with a standard deviation of 0.35. The aspect ratio of these pores is measured as 1.10.

The cell structure of the foam is unique as compared to other foams in that it appears shaped between a closed cell and open cell configuration. The large cells appear to be only weakly interconnected to each other and connected via the fine porosity so that the foam exhibits permeability in the presence of water but does not readily absorb more viscous liquids.

A series of carbon foams is produced by using different density precursor materials. The properties of the products are listed in Table I:

TABLE I

| | Foam 1 | Foam 2 | Foam 3 |
|---|---|---|---|
| Density g/cc | 0.266 | 0.366 | 0.566 |
| Compressive | 2263 | 4206 | 8992 |
| Strength (psi) | | | |
| Compressive | 8,507 | 12,517 | 16,713 |
| Strength/Density | | | |

Accordingly, by the practice of the present invention, carbon foams having heretofore unrecognized characteristics are prepared. These foams exhibit exceptionally high compressive strength to density ratios and have a distinctive bimodal cell structure, making them uniquely effective at applications, such as composite tooling applications.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A carbon foam article comprising a carbon foam substrate, an intermediate material on a surface of the carbon foam substrate, and a tool facing material on an outer surface of the article such that the intermediate material is positioned between the tool facing material and the carbon foam substrate.

2. The carbon foam article of claim 1 wherein the intermediate material comprises at least one of an elastomeric material, rigid material, and combinations thereof.

3. The carbon foam article of claim 2 wherein the intermediate material is in the form of a sheet.

4. The carbon foam article of claim 2 wherein the intermediate material is formed from more than one sheet, with adjacent sheets in a lapped relationship to each other.

5. The carbon foam article of claim 1 wherein the carbon foam substrate has a ratio of compressive strength to density of at least about 7000 psi/(g/cc).

6. The carbon foam article of claim 1 wherein the carbon foam substrate has a density of from about 0.05 to about 0.4 g/cc and a compressive strength of at least about 2000 psi.

7. The carbon foam article of claim 1 wherein the carbon foam substrate has a porosity of between about 65% and about 95%.

8. The carbon foam article of claim 1 wherein at least about 90% of the volume of the pores of the carbon foam substrate have a diameter of between about 10 and about 150 microns.

9. The carbon foam article of claim 8 wherein at least about 1% of the volume of the pores of the carbon foam substrate have a diameter of between about 0.8 and about 3.5 microns.

10. The carbon foam article of claim 1 wherein the carbon foam substrate has a nitrogen permeability of no greater than about 3.0 darcys.

11. The carbon foam article of claim 1 wherein the intermediate layer includes at least one material selected from the group of elastomer, benzoxazine, phenolic resin, modified polyimide resin, epoxy resin, epoxy-acrylic material, bismalimide resin film adhesive, polyimide, high temperature paste adhesive and combinations thereof.

12. A carbon foam article comprising:
(a) a carbon foam substrate having a pore distribution such that at least about 90% of the volume of the pores have a diameter of between about 10 and about 150 microns and at least about 1% of the volume of the pores have a diameter of between about 0.8 and about 3.5 microns;
(b) an intermediate material on a surface of the carbon foam substrate; and
(c) a tool facing material on an outer surface of the article, wherein the
intermediate material is positioned between the tool facing material and the carbon foam substrate.

13. The carbon foam article of claim 12 wherein the carbon foam substrate comprises more than one piece of carbon foam.

14. The carbon foam article of claim 12 wherein the carbon foam substrate has a density of less than 1.0 g/cc.

15. The carbon foam article of claim 12 wherein the intermediate material comprises at least one of an elastomeric material, rigid material, and combinations thereof.

16. The carbon foam article of claim 15 wherein the elastomeric material is in the form of a sheet or a cured viscous liquid.

17. The carbon foam article of claim 16 wherein the intermediate material is formed from more than one elastomeric sheet, with adjacent sheets in a lapped relationship to each other.

18. The carbon foam article of claim 12 wherein the carbon foam substrate has a ratio of compressive strength to density of at least about 7000 psi/(g/cc).

19. The carbon foam article of claim 12 wherein the carbon foam substrate has a density of from about 0.05 to about 0.4 and a compressive strength of at least about 2000 psi.

20. The carbon foam article of claim 12 wherein the intermediate layer includes at least one material selected from the group of elastomer, benzoxazine resin, phenolic resin, modified polyimide resin, epoxy resin, epoxy-acrylic material, bismalimide resin film adhesive, polyimide, high temperature paste adhesive and combinations thereof.
